(19) United States
(12) Patent Application Publication
(10) Pub. No.: US 2007/0195731 A1
(43) Pub. Date: Aug. 23, 2007

(54) Methods, systems and computer program products for establishing a point-to-point communication connection

(76) Inventor: William O. Camp JR., Chapel Hill, NC (US)

Correspondence Address: MYERS BIGEL SIBLEY & SAJOVEC, P.A., P.O. BOX 37428, RALEIGH, NC, 27627, US

(21) Appl. No.: 11/358,448

(22) Filed: Feb. 21, 2006

(51) Int. Cl. H04Q 7/00

(52) U.S. Cl. 370/329

(57) ABSTRACT

Methods of establishing a point-to-point communication connection using an uplink radio resource of a communication system include allocating an unused portion of the uplink radio resource of the communication system as a communication channel. The communication channel is assigned to establish the point-to-point communication connection.

### BACKGROUND OF THE INVENTION

The present invention relates to communication systems, methods and computer program products and, more particularly, to apparatus, methods and program products for set-up of communications.

A variety of different types of communications systems are used for communicating information, such as voice or data, between remote devices. These systems may be wired or wireless. While capacity limitations are a concern for both wired and wireless communication systems, they are generally more important for wireless systems, particularly as these systems expand from voice only communications support to providing a variety of data and media services that may require significant bandwidth to provide acceptable service to increasing numbers of consumers. Such wireless communications systems typically are restricted to use of a particular regulated portion of a wireless communication spectrum. Such restrictions may be important to limiting signal interference problems between overlapping ones of such systems. Accordingly, operators of wireless communication systems generally must balance addition of customers and services with available spectrum to provide services in a manner that will satisfy the expectations of those customers.

FIG. 1 illustrates a conventional terrestrial mobile (wireless) telecommunications network 20 that may implement any one of a variety of known wireless communications standards including uplink and downlink signals. A variety of wide area cellular networks are in use based on protocols, such as code division multiple access (CDMA), the Global System for Mobile communications (GSM) and the like. The wireless network may include one or more wireless mobile stations 22 that communicate with a plurality of cells 24 served by base stations 26 and a mobile telephone switching office (MTSO) 28. Although only three cells 24 are shown in FIG. 1, a typical cellular radiotelephone network may comprise hundreds of cells, and may include more than one MTSO 28 and may serve thousands of wireless mobile stations 22.

The cells 24 generally serve as nodes in the network 20, from which links are established between wireless mobile stations (terminals) 22 and a MTSO 28, by way of the base stations 26 servicing the cells 24. Each cell 24 will have allocated to it one or more dedicated control channels and one or more traffic channels. The control channel is a dedicated channel that may be used for downlink transmission (network to mobile) of cell identification and paging information. The traffic channels carry the voice and data information. Through the network 20, a duplex (downlink and uplink) radio communication link 30 may be effected between two wireless mobile stations 22 or between a wireless mobile station 22 and a landline telephone user 32 via a public switched telephone network (PSTN) 34. The function of the base station 26 is commonly to handle the radio communications between the cell 24 and the wireless mobile station 22. In this capacity, the base station 26 functions chiefly as a relay station for data and voice signals. It is also known to provide mobile telecommunications networks in which the base stations are satellites, having associated coverage areas, rather than terrestrial base stations.

Terminal location services may be provided by the network 20 using uplink and or downlink signals. In addition, other location approaches are known that are not associated with either the uplink or downlink signals used in the telecommunications network 20. For example, in a typically GPS application, the GPS receivers collect and analyze ranging measurements from signals transmitted by GPS satellites having known locations. Information from the GPS application may be available to the network 20 for use in tracking serviced mobile stations 22.

### SUMMARY OF THE INVENTION

Embodiments of the present invention include methods of establishing a point-to-point communication connection using an uplink radio resource of a communication system. An unused portion of the uplink radio resource of the communication system is allocated as a communication channel. The communication channel is assigned to establish the point-to-point communication connection. The communication system may be, for example, a wide area cellular network having substantially similar uplink and downlink data rates.

In other embodiments of the present invention, a request is received from a terminal to establish the point-to-point communication connection and/or availability of the unused portion of the uplink radio resource for use in establishing point-to-point communication connections is detected. Allocating the unused portion and assigning the communication channel are performed responsive to receiving the request from the terminal and/or detecting availability of the unused portion of the uplink radio resource.

In further embodiments, methods for establishing the point-to-point communication connection further include identifying a candidate communication connection between a first and a second terminal and determining if the candidate communication connection satisfies a point-to-point criterion. The candidate communication connection is selected for establishment as the point-to-point communication connection when the candidate communication connection satisfies the point-to-point criterion. An alternative communication connection that satisfies the point-to-point criterion is selected for establishment as the point-to-point communication connection when the candidate communication connection does not satisfy the point-to-point criterion.

In further embodiments, determining if the candidate communication connection satisfies the point-to-point criterion includes estimating a location of the first terminal and estimating a location of the second terminal. A distance between the first terminal and the second terminal is determined based on the estimated locations of the first and second terminals. The candidate communication connection is determined to satisfy the point-to-point criterion only if the determined distance between the first and the second terminal is less than a maximum distance. Determining if the candidate communication connection satisfies the point-to-point criterion may further include estimating a rate of change of the location of the first terminal and estimating a rate of change of the location of the second terminal. The candidate communication connection is determined to satisfy the point-to-point criterion only if the rate of change of the locations of the first and second terminals is less than a maximum rate. The maximum distance with or without the maximum rate may be selected based on a communication connection setup spectrum allocated for use in setting up and/or breaking down the point-to-point communication connection.

In other embodiments, assigning the communication channel includes assigning a traffic portion of the communication channel and a control portion of the communication channel to establish the point-to-point communication connection between a first and a second terminal. The first and/or the second terminal are configured to control the point-point communication connection using the assigned control portion. The first and/or the second terminal may be configured to control a transmit power used for the point-to-point communication connection based on a detected signal quality of the point-to-point communication connection and to request handoff of the point-to-point communication connection to a communication channel routed through the communication system based on the detected signal quality. A request to handoff the point-to-point communication connection may be received from the first and/or the second terminal and a replacement communication channel between the first terminal and the second terminal routed through the communication system may be established and the communication channel of the point-to-point communication connection may be re-allocated as an unused portion of the uplink radio resource of the communication system responsive to the received request to handoff the point-to-point communication connection.

In some embodiments, the communication system is a wide area cellular network and the replacement channel is established based on a cellular communication protocol of the wide area cellular network. The cellular communication protocol may be, for example, a wideband code division multiple access (WCDMA) protocol or a time division multiple access (TDMA) protocol.

In yet further embodiments, assigning the communication channel includes assigning the communication channel to establish the point-to-point communication connection between a first and a second terminal and the method further includes controlling use of the point-to-point communication connection by the first and second terminals using a system control channel established using a downlink radio resource of the communication system. The communication system may be a wide area cellular network and the system control channel may be a control channel that is used to control access to the wide area cellular network.

In other embodiments, the point-to-point connection is between a first terminal and a second terminal and the communication system is a wide area cellular network that allocates an uplink channel to the first terminal for use in communications from the first terminal to the wide area cellular network. Allocating an unused portion of the uplink radio resource includes establishing a full duplex communication channel having an associate frequency, code and/or time offset from the uplink channel allocated to the first terminal as the communication channel so that the first terminal does not concurrently transmit to the wide area cellular network using the uplink channel and receive communications from the second terminal on the full duplex communication channel.

In further embodiments, the wide area cellular network system is a WCDMA protocol network and allocating an unused portion of the uplink radio resource includes using a compressed mode of the WCDMA protocol network to provide a time offset between when the first terminal transmits signals to the WCDMA using the uplink channel and when the first terminal receives signals from the second terminal using the point-to-point communication connection. Allocating the unused portion of the uplink radio resource may further include using the compressed mode to provide a time offset between when the first terminal transmits signals to the WCDMA and receives signals from the second terminal and when the first terminal transmits to the second terminal using the point-to-point connection. Allocating the unused portion of the uplink radio resource may include assigning a same segment of the compressed mode but a assigning a different code for transmission of signals from the second terminal to the first terminal and transmissions from the first terminal to the second terminal using the point-to-point connection.

In other embodiments, the method further includes communicating between the first terminal and the second terminal using the point-to-point communication connection. The point-to-point communication connection may be a half-duplex communication connection.

In further embodiments, computer program products are provided for establishing a point-to-point communication connection using an uplink radio resource of a communication system. The computer program product includes computer program code embodied in a computer readable medium. The computer program code includes program code configured to allocate an unused portion of the uplink radio resource of the communication system as a communication channel and program code configured to assign the communication channel to establish the point-to-point communication connection.

In yet other embodiments, communication systems are provided including an allocation circuit configured to allocate an unused portion of an uplink radio resource of the communication system as a communication channel and an assignment circuit configured to assign the communication channel to establish a point-to-point communication connection. The systems may further include a selection circuit configured to select a candidate communication connection between a pair of terminals for establishment as the point-to-point communication connection based on a point-to-point criterion. The point-to-point criterion may be a distance between the pair of terminals. The communication systems may further include a detection circuit configured to detect a quality of the point-to-point communication connection and a handoff circuit configured to establish a replacement communication between the pair of terminals routed through the communication system and to handoff the point-to-point communication connection to the replacement communication channel based on a detected quality of the point-to-point communication connection.

### BRIEF DESCRIPTION OF THE DRAWINGS

FIG. 1 is a schematic block diagram illustrating a conventional terrestrial wireless communication system.

FIG. 2 is a block diagram of a communication system according to some embodiments of the present invention.

FIGS. 3 through 6 are flowcharts illustrating establishing a point-to-point communication connection according to various embodiments of the present invention.

FIG. 7 is a graphical illustration of a compressed mode segment allocation according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space.

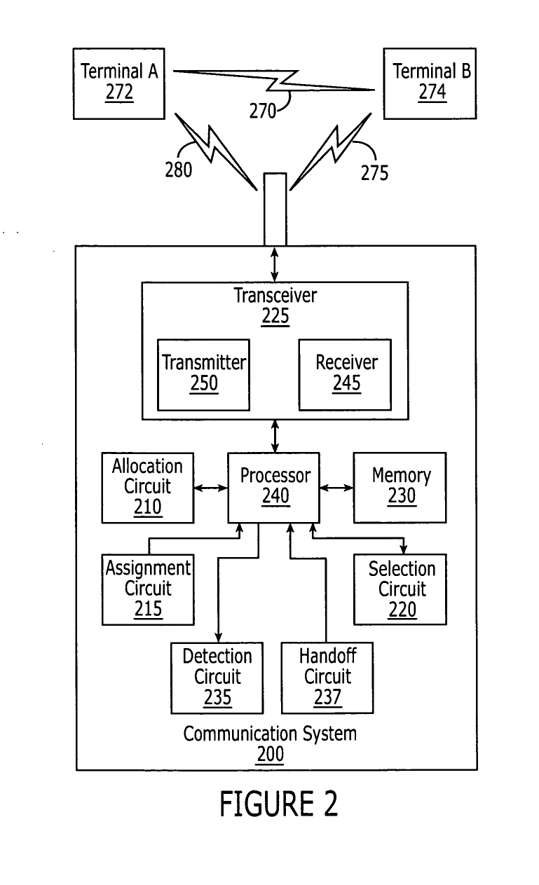

A communication system according to some embodiments of the present invention will now be described with reference to the block diagram illustration of FIG. 2. As shown in the embodiments of FIG. 2, a communication system 200 configured to establish point-to-point communication connections between terminals may include a network transceiver 225 for communicating with terminals. The network transceiver 225 typically comprises a transmitter circuit 250 and a receiver circuit 245, which respectively transmit outgoing radio frequency signals to terminals 272, 274 and receive incoming radio frequency signals from the terminals 272, 274 via an antenna 265. While a single antenna 265 is shown in FIG. 2, it is to be understood that multiple antennas and/or different types of antennas may be utilized based on the types of signals being received. The radio frequency signals transmitted between the communication system 200 and the terminals 272, 274 may comprise both traffic and control signals (e.g., paging signals/messages for incoming calls), which are used to establish and maintain communication with another party or destination, and may provide uplink and/or downlink communications.

As further shown in the embodiments of FIG. 2, the communication system 200 includes a processor 240 coupled to the transceiver 225. The processor 240 is also coupled to a memory 230 that may be used to store data, programs and the like used by the processor 240 in carrying out operations as will be described further herein. In addition, a variety of operational circuits are shown coupled to the processor 240, including an allocation circuit 210, an assignment circuit 215, a detection circuit 235, a handoff circuit 237 and a selection circuit 220. While shown as separate circuits in the embodiments of FIG. 2, it will be understood that, in various embodiments of the present invention the circuits 210, 215, 235, 237, 220 may be implemented in whole or in part as programmable code stored in the memory 230 and executed by the processor 240.

In some embodiments of the present invention, the allocation circuit 210 is configured to allocate an unused portion of an uplink radio resource of the communication system 200 as a communication channel. The assignment circuit 215 is configured to assign the communication channel to establish a point-to-point communication connection, for example, between terminal A 272 and terminal B 274 using the unused portion of the uplink radio resource of the communication system 200. Such a point-to-point communication connection is illustrated as communication connection 270 in FIG. 2. In some embodiments, the connection 270 may operate using existing methods and protocols, for example, such as Bluetooth. Also shown symbolically in FIG. 2 is a communication connection 275 between the communication system 200 and terminal B 274 and a communication connection 280 between the communication system 200 and terminal A 272. The communication connections 275, 280 may include uplink portions and downlink portions having different associated frequencies and/or codes that may be used for controlling communications and supporting communications by the terminals 272, 274 using the communication system 200 and further may be used to control communications over the point-to-point communication connection 270 in some embodiments of the present invention as will be further described herein. In embodiments where the connection 270 is implemented using a method and protocol such as Bluetooth, the communication system connections 275, 280 may still be used to control and monitor the connection 270, for example, to enable hand off back to the communication system 200 as needed.

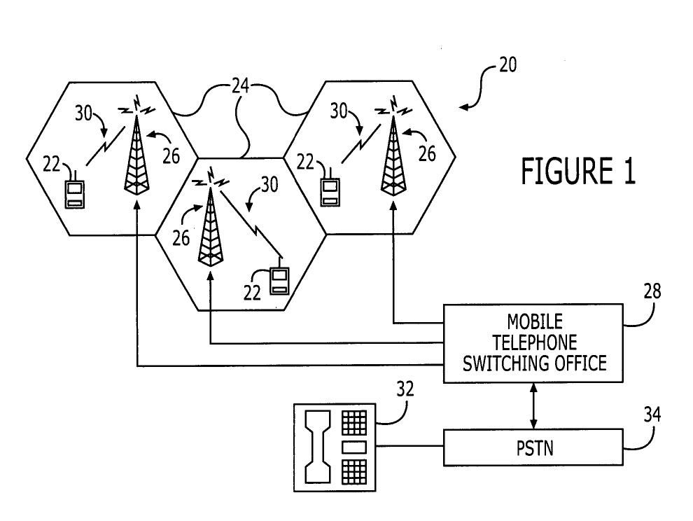

In various embodiments of the present invention, the communication system 200 is a wide area cellular network, such as the network 20 described with reference to FIG. 1. Such wide area cellular networks typically are allocated fixed radio resource by a regulating authority. That radio resource is allocated by the communication network service provider for uplink communications (communications from a terminal 272, 274 to the communication system 200) and downlink communications (used for communications from the communication system 200 to the terminals 272, 274). The frequency spectrum used for uplink and downlink communications may be non-overlapping frequency spectrum and/or may be overlapping frequency spectrum using different spreading codes or the like, both of which may be referred to as “uplink frequency spectrum” or “downlink frequency spectrum” herein.

As wide area cellular networks are generally designed for voice communications, the amount of traffic on the uplink and downlink directions is expected to be substantially similar. Accordingly, such networks generally allocate their radio resource so as to have substantially similar uplink and downlink data rates and capacity. However, while some of the newer data services supported by such a communication system 200 may require similarly balanced data rates, such as Voice over Internet Protocol (VoIP) and video conferencing, many of these new data services tend to consume more downlink radio resource than uplink. For example, the multimedia broadcast/multicast service (MBMS) is a unidirectional point to multipoint bearer service in which data is transmitted from a single source to multiple recipients. The data may be associated with services in the form, for example, of streaming video and audio. Services such as MBMS generally require little or no uplink capacity.

In communication systems having a balanced uplink and downlink capacity designed for supporting voice communications, an increased use of data services by subscribers, such as MBMS, may result in greatly underutilizing the uplink capacity. Therefore, it may be desirable for the operator of the communication system 200 to modify operations to make use of that unused uplink capacity even though the configuration and allocation of the radio resource available to communication system 200 may need to be maintained as a balanced uplink and downlink radio resource configuration for various other reasons. Accordingly, the allocation circuit 210 and assignment circuit 215 may operate to allow the communication system 200 to establish the point-to-point communication connection 270 between terminal A 272 and terminal B 274 using such unused uplink capacity. As such, a communication service may be provided to terminal A 272 and terminal B 274 without requiring utilization of much, if any, of the downlink radio resource of the communication system 200, thereby making that downlink radio resource available for use in establishing communication connections between terminals that are not located in a manner that would be suitable for use of a point-to-point communication connection.

As also shown in the schematic block diagram of FIG. 2, in some embodiments of the present invention, the communication system 200 includes the selection circuit 220 that is configured to select a candidate communication connection between a pair of terminals for establishment as the point-to-point communication connection 270 based on a point-to-point criterion. As will be further described herein, the point-to-point criterion may be, for example, a distance between a pair of terminals requesting a communication connection. Given typical limitations on both of the allowable transmission power used in the point-to-point communication connection 270 before interference may occur with other communications and power limitations on the respective terminals 272, 274, the terminals allocated a point-to-point communication connection 270 must generally be close enough for such a communication connection to work properly. The communication system 200 may determine terminals 272, 274 are close enough to each other for assignment of the point-to-point communication connection 270 using location techniques, such as GPS, terrestrial based location services, such as uplink time difference of arrival (TDOA) type approaches, and/or based on cell identification for the respective base station 26 and cell 24 where the terminals 272, 274 are registered and located.

A communication system 200 may further make an estimate of whether the terminals 272, 274 will remain close enough to each other for a sufficiently long period of time to make assignment of a point-to-point communication connection 270, rather than a conventional wide area cellular network communication channel, appropriate. Such an estimate may be based, for example, on determining a rate of change of the location of the terminals 272, 274, such as by monitoring doppler shifts and the like in the uplink signals or other rate of movement estimation techniques.

As also shown in FIG. 2, the communication system 200, according to some embodiments of the present invention, further includes the detection circuit 235 configured to detect the quality of the point-to-point communication connection 270. For example, when signal power levels associated with a point-to-point communication connection 270 drop below a specified criterion level, this may be interpreted as an indication that the point-to-point communication connection 270 is about to fail. These signal power level measurements in some embodiments may be reported to the communication system 200 via a communication system control channel or the like.

The handoff circuit 237 may be configured to establish a replacement communication connection between the pair of terminals 272, 274 routed through the communication system 200 responsive to an indication from the detection circuit 235 that the point-to-point communication connection 270 is about to fail. The handoff circuit 237 may further be configured to reallocate the portion of the uplink radio resource used as the communication channel for the point-to-point communication connection 270 as unused and to handoff the traffic from the point-to-point communication connection 270 to the replacement communication channel based on a detected quality of the point-to-point communication connection 270. The replacement communication connection may be supported by the communication connections 275, 280 through the communication system 200 as shown in FIG. 2.

As previously discussed, both the uplink and the downlink communication connections are generally regulated spectrum under the control of the communication system 200. Accordingly, as shown in the embodiments of FIG. 2, the allocation circuit 210 and the assignment circuit 215 may maintain control of the uplink spectrum under the control of the communication system 200 even when a portion of that spectrum is used as a point-to-point communication connection 270 between the terminals 272, 274. This control of the spectrum allocation may be maintained even in embodiments of the present invention where control of the point-to-point communication connection 270 itself is turned over to either terminal A 272 and/or terminal B 274 during use of the point-to-point communication connection 270 for communications. The communication system 200 may grant the terminals 272, 274 access to the uplink spectrum in a variety of manners including, but not limited to, assigning specific frequencies and/or spreading codes in the case of a CDMA system and/or time slots, frequencies and the like in a time division multiple access (TDMA) protocol communication system.

As all of the communications over the point-to-point communication connection 270 are in the uplink radio resource, the terminals 272, 274 may be configured to both transmit and receive signals in the uplink radio resource band as well as being configured to receive communications from the communication system 200 in the downlink frequency band. While, in some embodiments of the present invention, the terminals 272, 274 may be configured for simultaneous reception in both the uplink and downlink bands, such simultaneous reception is not used in other embodiments of the present invention. Furthermore, as will be understood from the general operations of wide band code division multiple access (WCDMA) systems and the like, as well as TDMA type systems, an unused portion of the uplink radio resource need not be an unused frequency but may be an unused spreading code, unused scrambling code, unused time window or the like using a frequency or frequencies in the uplink radio resource that are in use for other communications using different spreading codes, scrambling codes, time windows and/or the like.

As also noted previously, control over the point-to-point communication connection 270 may be maintained by the communication system 200 or some or all of the control may be turned over to the terminals 272, 274. Where the point-to-point communication connection 270 is intensively controlled by the communication system 200, the terminals 272, 274 may receive associated control instructions over the downlink portion of the communication connection channels 275, 280 between the respective terminals 272, 274 and the communication system 200, which communications may be provided in a manner substantially similar to the control channel operations for conventional wide area cellular communications through the communications system 200. In some embodiments, control is provided by the inclusion of additional appropriate commands within the control channel protocol. Thus, control operations over the point-to-point communication connection 270 may be simultaneously and compatibly provided with normal downlink control channel operations of the communication system 200 and normal downlink receiver operations in the terminals 272, 274, with appropriate modifications to implement the various operations associated with a point-to-point communication connection 270 as described herein.

Control of the point-to-point communication connection 270 may include, for example, power control of transmissions by the terminals 272, 274 in the uplink radio resource band used for the point-to-point communication connection 270. Such power transmission control may be under control of the communication system 200 or the terminals 272, 274 or a combination of both. If both, the communication system 200 may be configured to have the option to preempt power control by the terminals 272, 274, for example, to avoid interference to a base station 26 of the communication system 200 while listening to other terminals at the base station 26 during normal mode operations of the wide area cellular network. The direct terminal control of power may be provided by each terminal making power measurements of received signals and sending appropriate power transmission correction requests to the other terminal. Thus, the point-to-point communication connection 270 may be allocated so as to provide both traffic and control channel portions of the communication connection 270.

As discussed above, the handoff circuit 237 is configured to provide handoff of the point-to-point communication connection 270 based on a quality criterion or the like. The communication system 200 may provide additional monitoring of the progress of communications over the direct point-to-point communication connection 270 to determine, for example, when a call is completed or if it needs to be handed back to the communication system 200 for processing under normal wide area cellular network communication protocols for other reasons. In some embodiments, the point-to-point communication connection 270 may experience quality problems or the like that do not require conversion from point-to-point connection communications to conventional cellular communication connections. For example, a different frequency, spreading code, scrambling code, or the like associated with the uplink spectrum that is unused may be allocated that will provide better signal quality due to less interference or the like.

A transfer may be initiated based on detection of movement of the terminals in addition to or instead of the degradation of the signal quality in some embodiments as well. In any event, such monitoring of progress of the point-to-point communication connection 270 by the communication system 200, in various embodiments, may be provided using existing signaling commands on a wide area cellular network control channel of the communication system 200 and may include added signaling information messages transmitted using such a control channel. The addition of such new messages may permit greater control and possibly more seamless behavior integrating the point-to-point communication connection 270 more smoothly with wide area cellular communications supported by the communication system 200.

While control operations are generally described above in terms of signalling between terminals 272,274 and signalling between terminals 272,274 and the communication system 200, or a combination thereof, in some embodiments the communication system 200 may directly monitor the terminal to terminal signalling that occurs over link 270 by, for example, tuning a local cell basestation receiver 245 to the same radio resource channel as is used for the link 270. Thus, the signalling could be combined in a shared signalling structure in some embodiments.

In addition, while generally described as a two way communication connection that will appear to the terminals in performance substantially similar to a communication using the communication system 200 for uplink and downlink communications, the allocated point-to-point communication connection 270 in some embodiments may be a push-to-talk type connection sharing a single frequency, spreading code, scrambling code or the like between terminals 272, 274 and the terminals may be limited to only talk or listen and not full duplex operations when using the point-to-point communication connection 270 in such embodiments. Moreover, the communication connection 270 may also use more than one frequency, spreading code, scrambling code or the like to support full duplex communications between the terminals 272, 274.

While embodiments of the present invention have been illustrated in FIG. 2 with reference to particular divisions between circuits, the present invention should not be construed as limited to the configurations of FIG. 2 but is intended to encompass any configuration capable of carrying out the operations described herein. Furthermore the functionality described herein may be provided, for example by plug-ins or other ancillary code to provide functionality to existing applications.

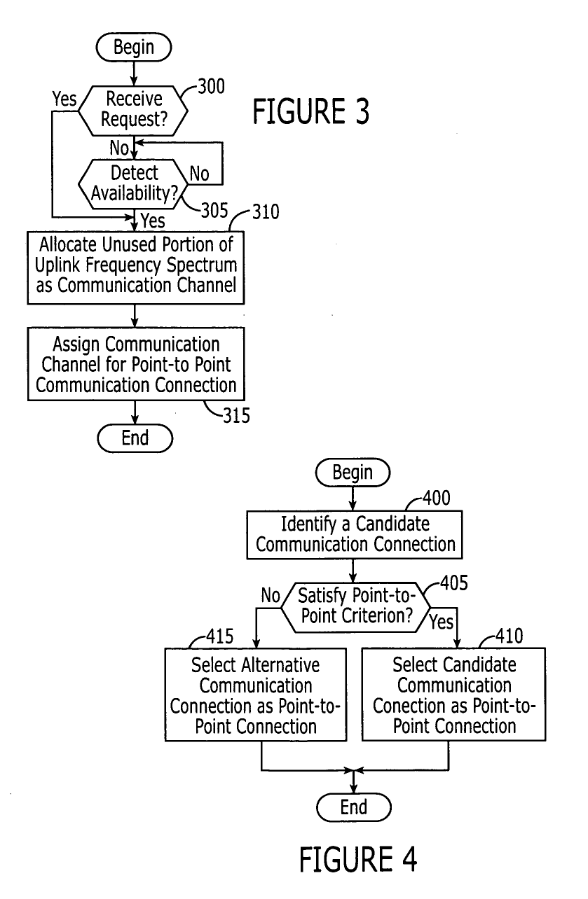

Operations for establishing a point-to-point communication connection according to various embodiments of the present invention will now be described with reference to the flow chart illustrations of FIGS. 3-6. Referring first to the embodiments illustrated in FIG. 3, operations for establishing a point-to-point communication connection using an uplink radio resource (which may also be referred to as an uplink frequency spectrum) of a communication system may be initiated by receiving a request from a terminal to establish a point-to-point connection (block 300) and/or detecting availability of an unused portion of the uplink radio resource (block 305). In any event, regardless of the cause for initiating establishment of a point-to-point communication connection, an unused portion of the uplink radio resource of the communication system 200 is allocated as a communication channel (block 310). The communication channel is assigned to establish the point-to-point communication connection (block 315). The assignment may be to a terminal providing the request for the connection at block 300 or otherwise identified by the communication system 200.

In some embodiments of the present invention, the communication system 200 may be a wide area cellular network that allocates an uplink channel to a first and/or second terminal 272, 274 that may use a point-to-point communication connection, where the uplink channel is used for communications from the first terminal to the wide area cellular network. In such embodiments, operations related to allocating an unused portion of the uplink radio resource at block 310 may include establishing a full duplex communication channel having an associated frequency, code, and/or time offset from the uplink channel allocated to the first terminal as the communication channel for use in the point-to-point communication connection so that the first terminal does not concurrently transmit to the wide area cellular network using the uplink channel and receive communications from the second terminal on the point-to-point communication connection. However, in other embodiments of the present invention, the first and/or second terminal 272, 274 may be configured so as to both transmit and receive on the uplink radio resource concurrently, for example, by inclusion of multiple transceivers therein. Furthermore, in other embodiments of the present invention as discussed above, a push-to-talk connection may be established rather than a full duplex communication point-to-point communication connection.

In particular embodiments, where the communication system 200 is a wide band code division multiple access (WCDMA) protocol network, operations related to allocating an unused portion of the uplink radio resource at block 310 may include using a compressed mode of the WCDMA protocol network to provide a time offset between when the first terminal transmits signals to the WCDMA network using the uplink channel and when the first terminal receives signals from the second terminal using the point-to-point communication connection. Operations at block 310 may further include using the compressed mode to provide a time offset between when the first terminal transmits signals to the WCDMA network and receives signals from a second terminal and when the first terminal transmits to the second terminal using the point-to-point communication connection 270. In other embodiments, operations at block 310 may include assigning a same segment of the compressed mode but assigning a different code for transmission of signals from the second terminal to the first terminal and transmission from the first terminal to the second terminal using the point-to-point communication connection.

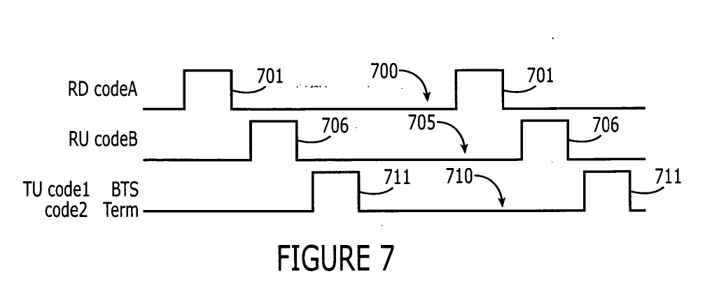

Use of compressed mode in a WCDMA system is further illustrated by the exemplary timing diagram illustration of FIG. 7. As shown in the graph 700 of FIG. 7, a first segment 701 is assigned to a terminal for receiving signals on the downlink radio resource using, for example, codeA. An offset segment 706 is assigned for use in receiving on the uplink radio resource as illustrated by the graph 705 and may use codeB. Finally, a third offset segment 711 is shown in the graph 710 for use in transmitting on the uplink radio resource. Separate codes may be used for transmissions to a base station 26 of the communication system 200 and to transmit over the point-to-point communication connection to a terminal 272, 274 and/or a same code may be used and a respective base station and receiving terminal may listen in on communications to the other destination.

Operations related to establishing a point-to-point communication connection according to further embodiments of the present invention will now be described with reference to the flowchart illustration of FIG. 4. As shown for the embodiments of FIG. 4, operations begin by identifying a candidate communication connection between the first and second terminals (block 400). For example, the identification may be based on a request received at block 300 of FIG. 3 from a requesting terminal. The request may also be, for example, an access request for establishing a conventional wide area cellular network communication connection and the communication system 200 may evaluate that request and decide to establish it as a point-to-point communication instead. If the candidate communication connection satisfies a point-to-point criterion (block 405), the candidate communication connection is selected for establishment as the point-to-point communication connection (block 410). If the candidate communication connection does not satisfy the point-to-point criterion (block 405), an alternative communication connection that does satisfy the point-to-point criterion is selected for establishment as the point-to-point communication connection (block 415).

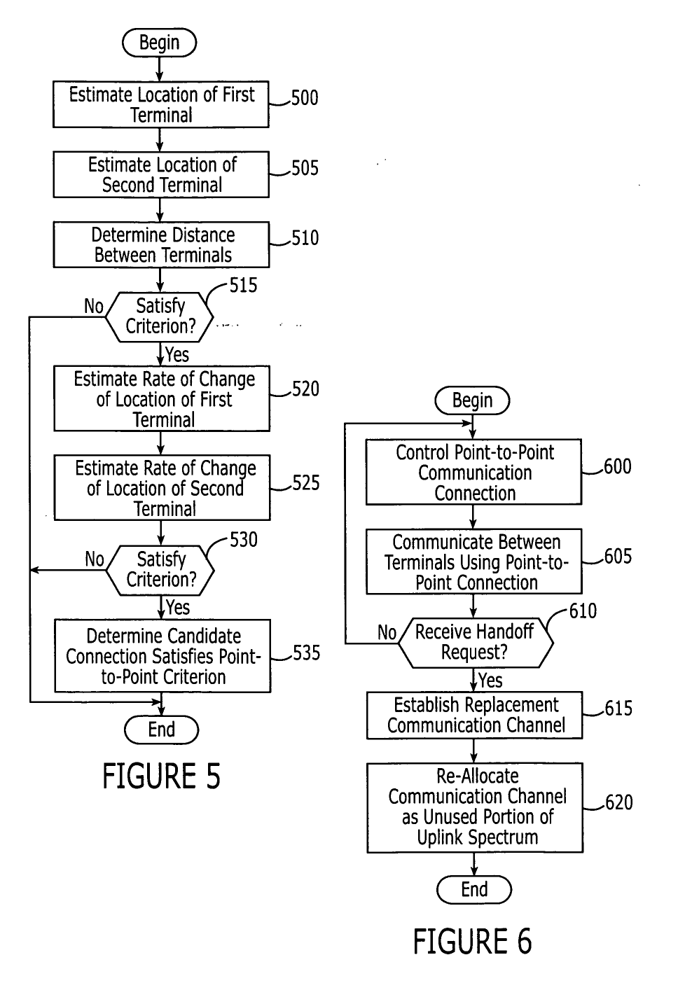

Further embodiments of methods for establishing a point-to-point communication connection using an uplink radio resource of the communication system 200 will now be described with reference to the flowchart illustration of FIG. 5. More particularly, FIG. 5 includes details, according to various embodiments of the present invention, of operations related to determining if a candidate communication connection satisfies the point-to-point criterion at block 405 of FIG. 4. For the embodiments illustrated in FIG. 5, operations begin by estimating a location of the first terminal (block 500) and estimating a location of the second terminal (block 505). A distance between the first terminal and the second terminal is determined based on the estimated locations of the first and second terminals (block 510). For example, the first and second terminal may be GPS enabled devices providing location information to the communication system 200, either directly or indirectly, and the communication system 200 may calculate a difference in the locations based on the known locations of the respective terminals.

In some embodiments, the communication system 200 itself may be configured to estimate the location of terminals served by the communication system 200, using, for example, capability provided by emergency calling protocols supported by various wide area cellular communication networks or other terrestrial based location determination systems. Where sufficient power for the point-to-point connection may be utilized without interference with other communications, it may be sufficient to merely identify a cell 24 (FIG. 1) in which each of the terminals is located to provide sufficient location estimation information to determine if a connection between the two terminals may be appropriately established using a point-to-point communication connection. The candidate communication connection is determined to satisfy the point-to-point criterion only if the determined distance between the first and the second terminal is less than a maximum distance (block 515).

In some embodiments of the present invention, if the maximum distance criterion is satisfied (block 515), a rate of change of the location of the first terminal is estimated (block 520) and a rate of change of the location of the second terminal is estimated (block 525). The candidate communication connection is determined to satisfy the point-to-point criterion in such embodiments only if the rates of change of the locations of the first and second terminals are less than a maximum rate (block 530). Thus, a communication system 200 may determine that the terminals are close enough to each other and further may determine that they are not moving too quickly before determining that it is appropriate to assign a point-to-point communication connection to the terminals. However, it will be understood that, in other embodiments of the present invention, the determination of suitability may be based solely on the location of the terminals without use of an additional assessment based on an estimation of a rate of change of locations of the terminals as an indication of how long a time period the terminals will likely stay in close enough distance to each other to make the terminals suitable for set-up and establishment of a point-to-point communication connection. In the embodiments illustrated in FIG. 5, it is determined that the candidate connection satisfied the point-to-point criterion only after both the location and rate of change criterion are satisfied (block 535).

The maximum distance and/or the maximum rate may be, selected in some embodiments, based on a communication connection set-up radio resource allocated for use in setting up and/or breaking down the point-to-point communication connection. Thus, a decision may be made not to allocate a point-to-point communication connection as a way of utilizing unused uplink radio resource where the duration of the point-to-point communication connection is estimated to be so short lived that the savings in downlink spectrum will be offset by the spectrum utilized in establishing the point-to-point communication connection and/or subsequent handing off of that connection to a conventional wide area cellular network communication connection.

Operations according to further embodiments of the present invention associated with establishing and using a point-to-point communication connection will now be further described with reference to the flowchart illustration of FIG. 6. As illustrated in FIG. 6, the point-to-point communication connection has already been established and operations include controlling use of the point-to-point communication connection by the first and second terminals (block 600) and communicating between the first terminal and the second terminal using the point-to-point communication connection (block 605).

As discussed previously, control of the point-to-point communication connection at block 600 may be carried out by the communication system 200, one or both of the terminals 272, 274 or a combination of the system 200 and the terminals 272, 274. The communication system 200 may provide control at block 600 using a system control channel established by the communication system 200 using a portion of a downlink radio resource of the communication system 200. The system control channel may be a specially established channel associated with the point-to-point communication connection and/or may be a control channel that is used to control access to the wide area cellular network in connection with conventional wide area cellular network communications. In either event, an existing signaling command and/or added signaling information messages may be used to control the point-to-point communication connection. Additional messages may be provided so as to allow greater control and/or more seamless behavior in transitioning between the point-to-point communication connection and conventional wide area cellular network communication channels of a connection between a first terminal and a second terminal.

As also shown in the embodiments of FIG. 6, if a request to handoff the point-to-point communication connection is received from the first and/or the second terminal (block 610), the communication system 200 establishes a replacement communication channel between the first terminal and the second terminal routed through the communication system 200 and hands off the point-to-point communication connection to the replacement communication channel (block 615). It will be understood that, in some embodiments of the present invention, a request may be initiated by the first terminal or the second terminal, for example, using a message on a control channel in the uplink radio resource of the communication system 200 or may be detected by the communication system 200 by monitoring signal strengths, quality or the like in the point-to-point communication connection and analysis of such information to identify automatically a request for handoff based on signal criteria or the like as applied to the monitored point-to-point communication connection. The communication system 200, after handoff, may also reallocate the spectrum from the communication channel of the point-to-point communication connection as an unused portion of the uplink radio resource of the communication system 200 so that the spectrum may be used in establishing other point-to-point communication connections (block 620).

In some embodiments, the communication system 200 is a wide area cellular network and the replacement channel is established based on cellular communication protocol of the wide area cellular network. The cellular communication protocol may be, for example, a wide band code division multiple access (WCDMA) protocol or a time division multiple access (TDMA) protocol.

Where control operations at block 600 are performed in whole or in part by the communicating terminals 272, 274, operations for assigning a communication channel at block 315 of FIG. 3 may include assigning a traffic portion of the communication channel and a control portion of the communication channel to establish the point-to-point communication connection. The first and/or second terminal 272, 274 may be configured to control the point-to-point communication connection using the assigned control portion of the communication channel. For example, each of the terminals may monitor a signal strength and/or quality of signals received on the traffic portion of the communication channel and provide commands using the control portion to the transmitting terminal to request an adjustment in transmit power or the like. They may further be configured, in other embodiments, to transmit requests to the communication system 200 for allocation of a different frequency, spreading code, scrambling code or the like that is expected to provide a better signal quality. The first and/or second terminal 272, 274 may also be configured to provide a request for handoff at block 610 of FIG. 6 based on a comparison of a detected signal quality of the point-to-point communication connection to a handoff criterion.

As will be appreciated by one of skill in the art, the present invention may be embodied as a method, circuit or communication system. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described above with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of establishing a point-to-point communication connection using an uplink radio resource of a communication system, comprising:
allocating an unused portion of the uplink radio resource of the communication system as a communication channel;
assigning the communication channel to establish the point-to-point communication connection.

2. The method of claim 1, wherein the communication system comprises a wide area cellular network having substantially similar uplink and downlink data rates.

3. The method of claim 1, further comprising:
receiving a request from a terminal to establish the point-to-point communication connection; and/or
detecting availability of the unused portion of the uplink radio resource for use in establishing point-to-point communication connections; and
wherein allocating the unused portion and assigning the communication channel are performed responsive to receiving the request from the terminal and/or detecting availability of the unused portion of the uplink radio resource.

4. The method of claim 3, further comprising:
identifying a candidate communication connection between a first and a second terminal;
determining if the candidate communication connection satisfies a point-to-point criterion; and
selecting the candidate communication connection for establishment as the point-to-point communication connection when the candidate communication connection satisfies the point-to-point criterion and selecting an alternative communication connection that satisfies the point-to-point criterion for establishment as the point-to-point communication connection when the candidate communication connection does not satisfy the point-to-point criterion.

5. The method of claim 4, wherein determining if the candidate communication connection satisfies the point-to-point criterion comprises:
estimating a location of the first terminal;
estimating a location of the second terminal;
determining a distance between the first terminal and the second terminal based on the estimated locations of the first and second terminals; and
determining that the candidate communication connection satisfies the point-to-point criterion only if the determined distance between the first and the second terminal is less than a maximum distance.

6. The method of claim 5, wherein determining if the candidate communication connection satisfies the point-to-point criterion comprises:
estimating a rate of change of the location of the first terminal;
estimating a rate of change of the location of the second terminal; and
determining that the candidate communication connection satisfies the point-to-point criterion only if the rate of change of the locations of the first and second terminals is less than a maximum rate.

7. The method of claim 6, wherein the maximum distance and/or the maximum rate are selected based on a communication connection setup spectrum allocated for use in setting up and/or breaking down the point-to-point communication connection.

8. The method of claim 1, wherein assigning the communication channel comprises assigning a traffic portion of the communication channel and a control portion of the communication channel to establish the point-to-point communication connection between a first and a second terminal and wherein the first and/or the second terminal are configured to control the point-to-point communication connection using the assigned control portion.

9. The method of claim 8, wherein the first and/or the second terminal are configured to control a transmit power used for the point-to-point communication connection based on a detected signal quality of the point-to-point communication connection and to request handoff of the point-to-point communication connection to a communication channel routed through the communication system based on the detected signal quality and wherein the method further comprises:
receiving a request to handoff the point-to-point communication connection from the first and/or the second terminal; and
establishing a replacement communication channel between the first terminal and the second terminal routed through the communication system and re-allocating the communication channel of the point-to-point communication connection as an unused portion of the uplink radio resource of the communication system responsive to the received request to handoff the point-to-point communication connection.

10. The method of claim 9, wherein the communication system comprises a wide area cellular network and wherein the replacement channel is established based on a cellular communication protocol of the wide area cellular network.

11. The method of claim 10, wherein the cellular communication protocol comprises a wideband code divisional multiple access (WCDMA) protocol or a time division multiple access (TDMA) protocol.

12. The method of claim 1, wherein assigning the communication channel comprises assigning the communication channel to establish the point-to-point communication connection between a first and a second terminal and wherein the method further comprises controlling use of the point-to-point communication connection by the first and second terminals using a system control channel established using a downlink radio resource of the communication system.

13. The method of claim 12, wherein the communication system comprises a wide area cellular network and wherein the system control channel comprises a control channel that is used to control access to the wide area cellular network.

14. The method of claim 1, wherein the point-to-point communication connection is between a first terminal and a second terminal and wherein the communication system comprises a wide area cellular network that allocates an uplink channel to the first terminal for use in communications from the first terminal to the wide area cellular network and wherein allocating an unused portion of the uplink radio resource comprises establishing a full duplex communication channel having an associated frequency, code and/or time offset from the uplink channel allocated to the first terminal as the communication channel so that the first terminal does not concurrently transmit to the wide area cellular network using the uplink channel and receive communications from the second terminal on the full duplex communication channel.

15. The method of claim 14, wherein the wide area cellular network system comprises a wideband code divisional multiple access (WCDMA) protocol network and wherein allocating an unused portion of the uplink radio resource comprises using a compressed mode of the WCDMA protocol network to provide a time offset between when the first terminal transmits signals to the WCDMA using the uplink channel and when the first terminal receives signals from the second terminal using the point-to-point communication connection.

16. The method of claim 15, wherein allocating the unused portion of the uplink radio resource further comprises using the compressed mode to provide a time offset between when the first terminal transmits signals to the WCDMA and receives signals from the second terminal and when the first terminal transmits to the second terminal using the point-to-point connection.

17. The method of claim 15, wherein allocating the unused portion of the uplink radio resource further comprises assigning a same segment of the compressed mode but assigning a different code for transmission of signals from the second terminal to the first terminal and transmissions from the first terminal to the second terminal using the point-to-point communication connection.

18. The method of claim 1, wherein assigning the communication channel comprises assigning the communication channel to a first terminal and a second terminal and wherein the method further comprises communicating between the first terminal and the second terminal using the point-to-point communication connection.

19. The method of claim 1, wherein the point-to-point communication connection comprises a half-duplex communication connection.

20. A computer program product for establishing a point-to-point communication connection using an uplink radio resource of a communication system, the computer program product comprising computer program code embodied in a computer readable medium, the computer program code comprising program code configured to carry out the method of claim 1.

21. A communication system configured to carry out the method of claim 1.

22. A computer program product for establishing a point-to-point communication connection using an uplink radio resource of a communication system, the computer program product comprising computer program code embodied in a computer readable medium, the computer program code comprising:
program code configured to allocate an unused portion of the uplink radio resource of the communication system as a communication channel; and
program code configured to assign the communication channel to establish the point-to-point communication connection.

23. A communication system, comprising:
an allocation circuit configured to allocate an unused portion of an uplink radio resource of the communication system as a communication channel; and
an assignment circuit configured to assign the communication channel to establish a point-to-point communication connection.

24. The communication system of claim 23, further comprising a selection circuit configured to select a candidate communication connection between a pair of terminals for establishment as the point-to-point communication connection based on a point-to-point criterion.

25. The communication system of claim 24, wherein the point-to-point criterion comprises a distance between the pair of terminals.

26. The communication system of claim 23, further comprising:
a detection circuit configured to detect a quality of the point-to-point communication connection; and
a handoff circuit configured to establish a replacement communication between the pair of terminals routed through the communication system and to handoff the point-to-point communication connection to the replacement communication channel based on a detected quality of the point-to-point communication connection.
